(19) United States
(12) Patent Application Publication
(10) Pub. No.: US 2009/0119610 A1
(43) Pub. Date: May 7, 2009

(54) AGENT TO OFFER IN-CONTEXT HELP

(75) Inventors: Daniel Joseph Raffel, San Francisco, CA (US); Jonathan James Trevor, Santa Clara, CA (US); Pasha Sadri, Menlo Park, CA (US); Edward Ho, San Jose, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/934,594

(22) Filed: Nov. 2, 2007

(51) Int. Cl. G06F 3/048

(52) U.S. Cl. 715/771

(57) ABSTRACT

User assistance functionality is associated with an application. The application is executed, including receiving input from a user to dynamically define a configuration of modules which may then be interpreted or compiled for execution. The configuration of modules may be, for example, a pipe, which is a configuration of constituent pipes, each constituent pipe having an input and an output for inputting and outputting, respectively, a syndication data feed, and the constituent pipes connected by wires for transmission of the syndication data feeds among the pipes. As the configuration of modules is being dynamically defined based on user input, which includes sequentially configuring a plurality of intermediate arrangements of constituent modules, an application assistance interface is dynamically determined to be displayed based on a context of a current one of the plurality of intermediate arrangements of constituent modules.

### BACKGROUND

Applications, whether provided locally, remotely, or a combination of both, are many times not intuitive for at least some users to operate. As a result, many applications provide user assistance functionality. One type of user assistance functionality is accessible via a help menu, which is typically not contextually tied to the functions for which help is requested. Thus, for example, a user desiring assistance with a function may need to first access a help menu and then type, in a search field of a help function, a keyword relating to the function after accessing the help menu, which would then result in textual and/or graphic material being displayed that may then be of assistance in using the function.

Other types of user assistance are more contextually tied to the function for which help is desired. For example, one type of user assistance includes providing a text balloon with information about a particular feature whenever the cursor is rolled a portion of the display for that feature.

### SUMMARY

In accordance with an aspect, at least one computing device provides user assistance functionality associated with an application. The application is executed, including receiving input from a user to dynamically define an arrangement of modules which may then be interpreted or compiled for execution. The arrangement of modules may be, for example, a pipe, which is an arrangement of constituent pipes, each constituent pipe having an input and an output for inputting and outputting, respectively, a syndication data feed, and the constituent pipes connected by wires for transmission of the syndication data feeds among the pipes.

As the configuration of modules is being dynamically defined based on user input, which includes sequentially configuring a plurality of intermediate arrangements of constituent modules, an application assistance interface is dynamically determined to be displayed based on a context of a current one of the plurality of intermediate arrangements of constituent modules.

### BRIEF DESCRIPTION OF THE DRAWINGS

FIG. 1 is an example architecture of a system in which an application is executed to receive input from a user to dynamically define a configuration of constituent modules, and the system is configured to dynamically determine an application assistance interface based on a context of a current one of a plurality of intermediate arrangements of constituent modules.

FIG. 2 is a flowchart illustrating a method of generating the indications relative to existing pipes that may be provided, for example, to a suggestion portion a user assistance interface generator.

FIG. 3 illustrates an example screen shot of a display of a pipe specification editor program including a generated suggestion displayed in conjunction with a current intermediate arrangement of constituent pipes of an in-process pipe definition.

FIG. 4 is a simplified diagram of a network environment in which specific embodiments of the present invention may be implemented.

### DETAILED DESCRIPTION

The inventors have realized that it would be desirable to provide a user-assistance interface for an executing application, wherein the executing application is configured to receive input from a user to dynamically define an arrangement of constituent modules. The defined arrangement of constituent modules may then be interpreted or compiled for execution. The arrangement of modules may be, for example, a pipe, which is an arrangement of constituent pipes, each constituent pipe having an input and an output for inputting and outputting, respectively, a syndication data feed, and the constituent pipes connected by wires for transmission of the syndication data feeds among the constituent pipes. As a user is interacting with the module arrangement application, there is a sequence of intermediate arrangements of modules (which includes configurations of individual modules), the intermediate arrangements depending on user input.

The inventors have realized that it would be desirable for the module arrangement application to include an application-assistance interface that is dynamically determined based on a context of a current intermediate arrangement of constituent modules. In this way, the user can be assisted to determine next intermediate arrangements of modules, to arrive at a final arrangement of constituent modules.

For example, it has been disclosed in U.S. Pat. No. 11/613,960 (YAH1P039/Y01804US01, “the '960 application”), filed Dec. 20, 2006, to use a “pipes editor” application to configure a “pipe specification” to “wire together” component pipes to process syndication data feeds. (The '960 application is hereby incorporated by reference in its entirety.) More particularly, a process has been disclosed in the '960 application by which one may effect the remixing of syndication data feeds and, furthermore, to create syndication feed data “mashups” to combine content from more than one source, including at least one syndication data feed, into an integrated experience. As described in the '960 application, each module is characterized by at least one of a group consisting of an input node and an output node, wherein the input node, if present, is configured to input a syndication data feed and the output node, which is generally present, is configured to output a syndication data feed. At least one of the modules is a module configured to retrieve a source syndication data feed. The wires are configured to provide a syndication data feed provided from an output node of a module to an input node of another module.

As described and illustrated in the '960 application, a user may interact with the pipes editor to cause modules to be connected using wires. Using the graphical user interface, modules may be “dragged” or otherwise caused to be displayed in the interface, and the output of a module may be “dragged” to the input of another module, to wire a one-way data connection between the two modules. Repeating this process, modules (which may themselves be defined as combinations of modules) may be connected together (and configured) to achieve a desired behavior when the pipe is “run.”

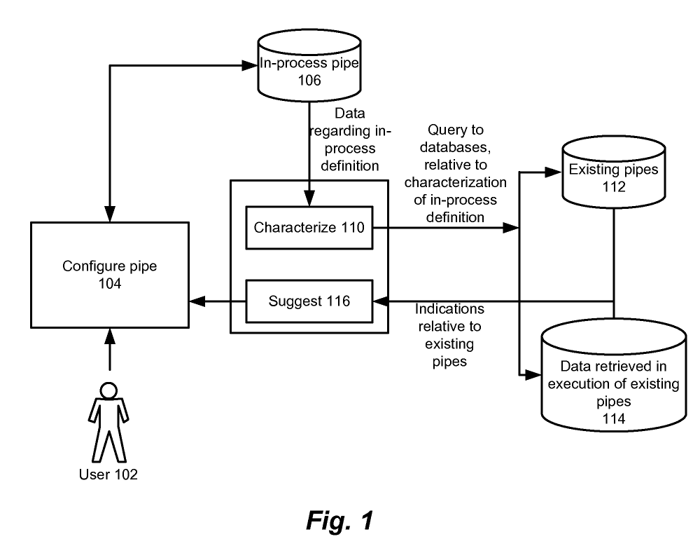

At each step of the connecting and/or configuring, there are typically many possible choices that could be made with respect to further additional connecting and/or configuring. Many of the choices may be informed by the present arrangement and/or configuration of the modules. We now describe, with reference to FIG. 1, an architecture of a system in which an application is executed to receive input from a user to dynamically define a configuration of constituent modules (in the FIG. 1 example, a pipe) which may then be interpreted or compiled for execution. In particular, the system is configured to dynamically determine an application assistance interface based on a context of a current one of a plurality of intermediate arrangements of constituent modules.

Referring now to FIG. 1, a user 102 interacts with an executing application 104 that receives input from the user to dynamically define a configuration of constituent modules of a pipe. As the constituent modules are being configured, an “in-process pipe” definition 106 is being maintained and displayed to the user by the pipe configuration program 104.

Data regarding the in-process pipe definition 106 is provided to a user assistance interface generator 108. More particularly, a characterize portion 110 of the user assistance interface generator 110 uses the data regarding the in-process pipe definition 106 to generate a query to databases (more generally, a collection of data) such as an existing pipes database 112 and a database 114 of data retrieved in execution of existing pipes. The data retrieved in execution of existing pipes may include, for example, data included in syndication data feeds accessed in execution of existing pipes or data retrieved using a web service in execution of existing pipes. The data may not be in its raw form (i.e., as accessed in a syndication data feed or as retrieved using a web service) but, rather, may be in a form as processed (for example, as an intermediate result) during a previous execution of an existing pipe.

Indications relative to existing pipes, obtained a result of querying one or more databases relative to the existing pipes, are provided to a suggestion portion 116 of the user assistance interface generator 108. The suggestion is provided to the user for display by the pipe configuration application 104 in conjunction with a display of the pipe configuration editor program corresponding to the current one of the plurality of intermediate arrangements of constituent pipe.

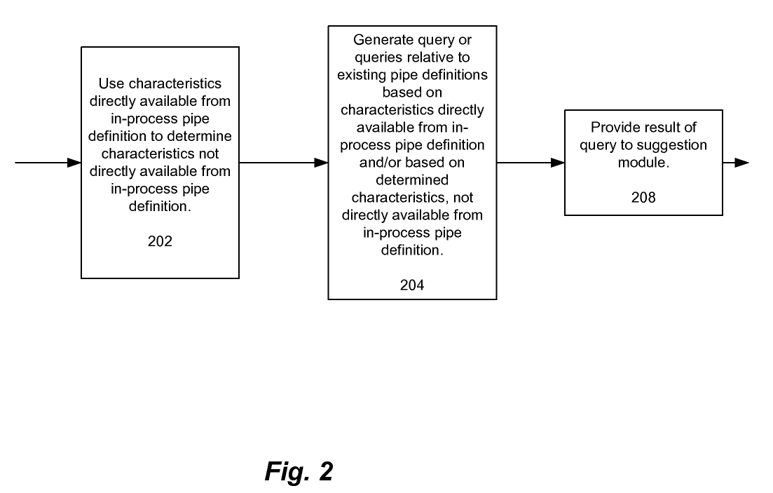

We now turn to FIG. 2, which is a flowchart illustrating a method of generating the indications relative to existing pipes that may be provided, for example, to the suggestion portion 116 of the user assistance interface generator 108. At 202, characteristics directly available from the in-process pipe definition are used to determine characteristics not directly available from the in-process pipe definition. Characteristics directly available from in-process pipe definitions may include, for example, the particular modules, and/or constituent pipes generally, present in the in-process pipe definition. Other such characteristics may include, for example, field names entered into user input boxes relative to modules, and/or constituent pipes generally. Yet other such characteristics may include, for example, particular choices of static menu options. An example of static dropdown menu options may include, for example, in a “filter” module, an indication by the user to filter based on a condition of “contains” the keyword “pizza”.

Determined characteristics may include, for example, determining dynamic dropdown menu options for a module (not themselves directly available from the in-process pipe definition) depending on the dynamic content of a particular data source to which the module is connected to receive input. For that matter, such characteristics may include, for example, filtered dynamic content within a pipe, without regard for dynamic menu options. As one example, it may be determined that the filtered content within a pipe is about highly-rated pizza shops (which may result, for example, in a suggestion to employ a pipe that is about highly-rated pizza shops).

At 204, a query or queries is generated to a database relative to existing pipe definitions based on characteristics directly available from in-process pipe definitions and/or from characteristics determined using characteristics that are directly available from in-process pipe definitions.

At 206, a result of the queries is used to generate a suggestion or suggestions to provide to the user of the pipe configuration application in conjunction with a display of the pipe specification editor program corresponding to the current one of the plurality of intermediate arrangements of constituent pipes of the in-process pipe definition.

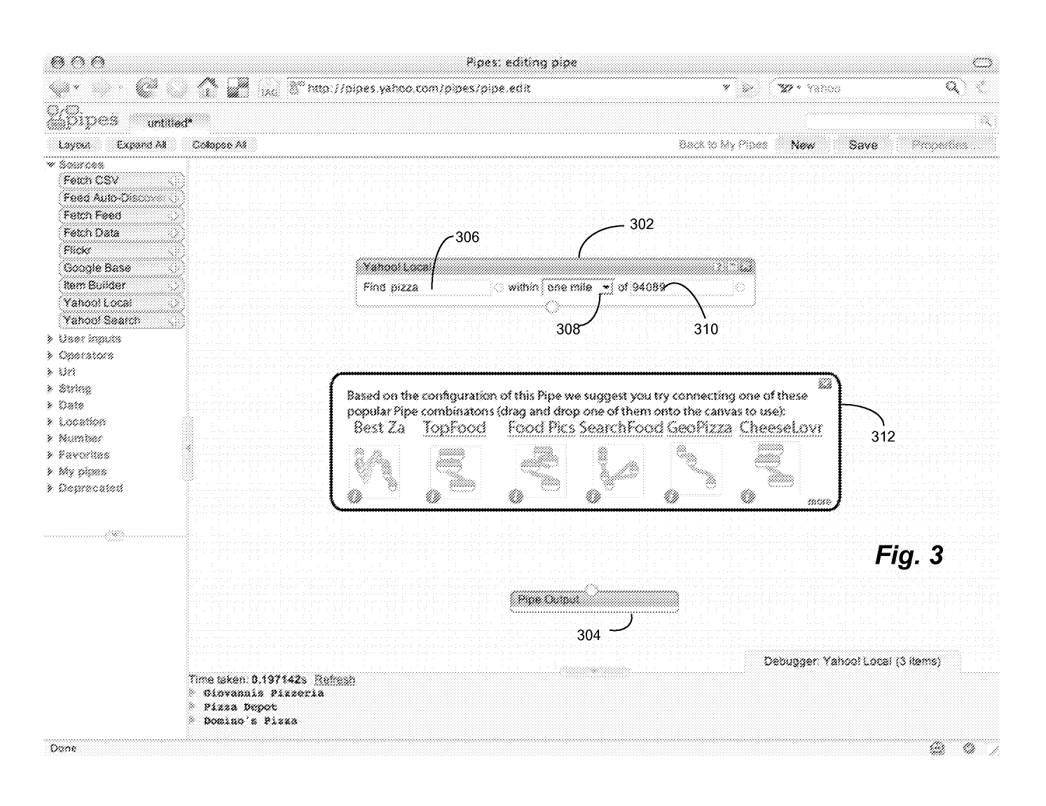

FIG. 3 illustrates an example screen shot of a display of a pipe specification editor program including a generated suggestion displayed in conjunction with a current intermediate arrangement of constituent pipes of an in-process pipe definition. In the FIG. 3 example screen shot, constituent pipes 302 and 304 are arranged in an unconnected configuration. In FIG. 3, the constituent pipes 302 and 304 are modules but, in some configurations, the constituent pipes are pipes that are not modules. This concept of constituent pipes and modules is discussed in the '960 application. The “Yahoo! Local” module 302 includes an input field 306 (in which a user has input the term “pizza”) and an input field 310 (in which a user has input the term “94089”). A static pulldown menu 308 indicates a selection of the criteria “one mile.”

The portion 312 of the screen shot is a display of a suggestion to the user. The portion 312 includes suggested constituent pipes to include in a next intermediate arrangement of constituent pipes. The user assistance interface is configured such that one of the constituent pipes in the portion 312 may be “dragged” into the constituent pipes arrangement. This is one example of a suggestion, and other examples are possible as well.

It can be seen from the previous discussion that the substance of the suggestion may depend on characteristics directly available from the in-process pipe definition; characteristics not directly available from the in-process pipe definition and determined (and the method of determining) from characteristics that are directly available from the in-process pipe definition; how the query or queries are generated; the data relative to existing pipes; and how the suggestion or suggestions are generated based on the indications returned in response to the queries.

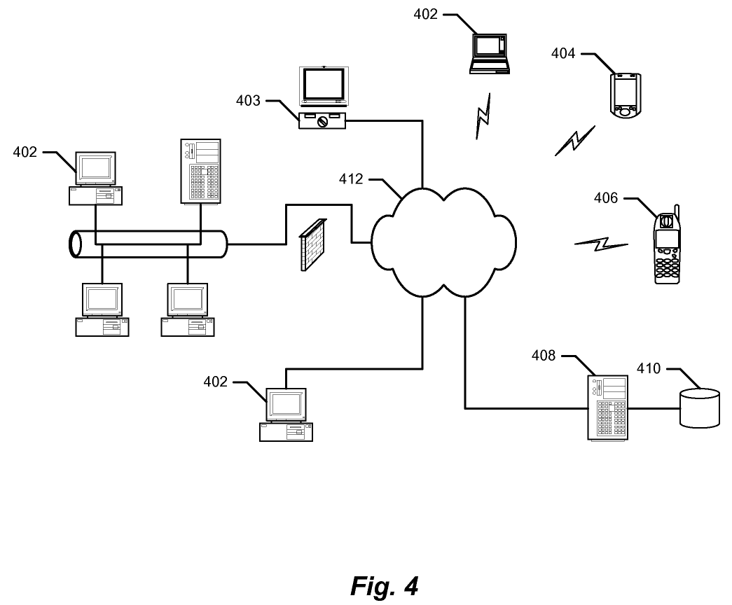

Embodiments of the present invention may be employed in any of a wide variety of computing contexts to provide supplemental material that is appropriate to a nominal expected retrieval and processing time and/or is appropriate to a nominal expected content of the processed specifications for mixing and matching data resulting from various web service calls s. For example, as illustrated in FIG. 4, implementations are contemplated in which users may interact with a diverse network environment via any type of computer (e.g., desktop, laptop, tablet, etc.) 402, media computing platforms 403 (e.g., cable and satellite set top boxes and digital video recorders), handheld computing devices (e.g., PDAs) 404, cell phones 406, or any other type of computing or communication platform.

According to various embodiments, applications may be executed locally, remotely or a combination of both. The remote aspect is illustrated in FIG. 4 by server 408 and data store 410 which, as will be understood, may correspond to multiple distributed devices and data stores.

The various aspects of the invention may also be practiced in a wide variety of network environments (represented by network 412) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

What is claimed is:

1. A method, implemented by at least one computing device, of providing user assistance functionality associated with execution of a pipe specification editor application, wherein the pipe specification editor program includes functionality for a user to configure a pipe, for processing one or more syndication data feeds, via a pipe specification graphical user interface by sequentially defining a plurality of intermediate arrangements of constituent pipes, the method comprising:
while a user is interacting with the pipe specification editor program, dynamically determining an application assistance interface to be displayed based on a context of a current one of the plurality of intermediate arrangements of constituent pipes; and
causing the dynamically determined application assistance interface to be displayed in conjunction with a display of the pipe specification editor program corresponding to the current one of the plurality of intermediate arrangements of constituent pipes.

2. The method of claim 1, wherein:
dynamically determining the application assistance interface includes
determining existing pipes also having those characteristics based on characteristics of the context of the current intermediate arrangement of constituent pipes; and
determining the application assistance interface to suggest, as a suggested next intermediate arrangement of constituent pipes, one or more arrangements having characteristics of the determined existing pipes, other than the characteristics of the context of the current intermediate arrangement of constituent pipes.

3. The method of claim 1, wherein:
dynamically determining the application assistance interface includes
determining existing pipes also having associated data content having those characteristics based on characteristics of dynamic content of a particular data source to which one of the constituent pipes of the current intermediate arrangement is connected to receive input;
determining the application assistance interface to suggest, as a suggested next intermediate arrangement of constituent pipes, one or more arrangements having characteristics of the determined existing pipes, other than the characteristics of the context of the current intermediate arrangement of constituent pipes.

4. The method of claim 3, wherein:
determining existing pipes also having associated data content having those characteristics includes referring to a collection of data that was previously retrieved in execution of the existing pipes.

5. The method of claim 3, wherein:
determining characteristics of dynamic content of a particular data source to which one of the constituent pipes of the current intermediate arrangement is connected to receive input based on dynamic dropdown menu options of the one constituent pipe.

6. The method of claim 1, wherein:
the characteristics of the context of the current intermediate arrangement of constituent pipes on which the dynamic determination of the application assistance interface is based includes particular constituent pipes present in the current intermediate arrangement.

7. The method of claim 1, wherein:
the characteristics of the context of the current intermediate arrangement of constituent pipes includes user-defined configurations of one or more particular constituent pipes.

8. The method of claim 7, wherein the user-defined configurations include at least one of the group consisting of field names entered into user input boxes relative to constituent pipes and particular choices of static menu options of the constituent pipes.

9. The method of claim 1, wherein:
causing the dynamically determined application assistance interface to be displayed in conjunction with a display of the pipe specification editor program corresponding to the current one of the plurality of intermediate arrangements of constituent pipes includes causing the determined application assistance interface to be displayed superimposed on a display of the pipe specification editor program.

10. The method of claim 1, wherein:
the dynamically determined application assistance interface includes a plurality of suggested ones of the existing pipes to include as constituent pipes in a next intermediate arrangement of constituent pipes.

11. The method of claim 1, further comprising:
receiving an indication from a user of interaction with the dynamically determined application assistance interface and, based thereon, determining a next intermediate arrangement of constituent pipes.

12. A computer program product for providing user assistance functionality associated with execution of a pipe specification editor application, wherein the pipe specification editor program includes functionality for a user to configure a pipe, for processing one or more syndication data feeds, via a pipe specification graphical user interface by sequentially defining a plurality of intermediate arrangements of constituent pipes, the computer program product comprising at least one computer-readable medium having computer program instructions stored therein which are operable to cause at least one computing device to:
dynamically determine an application assistance interface to be displayed based on a context of a current one of the plurality of intermediate arrangements of constituent pipes while a user is interacting with the pipe specification editor program; and
cause the dynamically determined application assistance interface to be displayed in conjunction with a display of the pipe specification editor program corresponding to the current one of the plurality of intermediate arrangements of constituent pipes.

13. The computer program product of claim 12, wherein:
dynamically determining the application assistance interface includes
determining existing pipes also having those characteristics based on characteristics of the context of the current intermediate arrangement of constituent pipes; and
determining the application assistance interface to suggest, as a suggested next intermediate arrangement of constituent pipes, one or more arrangements having characteristics of the determined existing pipes, other than the characteristics of the context of the current intermediate arrangement of constituent pipes.

14. The computer program product of claim 12, wherein:
dynamically determining the application assistance interface includes
based on characteristics of dynamic content of a particular data source to which one of the constituent pipes of the current intermediate arrangement is connected to receive input, determining existing pipes also having associated data content having those characteristics;
determining the application assistance interface to suggest, as a suggested next intermediate arrangement of constituent pipes, one or more arrangements having characteristics of the determined existing pipes, other than the characteristics of the context of the current intermediate arrangement of constituent pipes.

15. The computer program product of claim 14, wherein:
determining existing pipes also having associated data content having those characteristics includes referring to a collection of data that was previously retrieved in execution of the existing pipes.

16. The computer program product of claim 14, wherein:
determining characteristics of dynamic content of a particular data source to which one of the constituent pipes of the current intermediate arrangement is connected to receive input based on dynamic dropdown menu options of the one constituent pipe.

17. The computer program product of claim 12, wherein:
the characteristics of the context of the current intermediate arrangement of constituent pipes on which the dynamic determination of the application assistance interface is based includes particular constituent pipes present in the current intermediate arrangement.

18. The method of claim 12, wherein:
the characteristics of the context of the current intermediate arrangement of constituent pipes includes user-defined configurations of one or more particular constituent pipes.

19. The computer program product of claim 18, wherein the user-defined configurations include at least one of the group consisting of field names entered into user input boxes relative to constituent pipes and particular choices of static menu options of the constituent pipes.

20. The method of claim 12, wherein:
causing the dynamically determined application assistance interface to be displayed in conjunction with a display of the pipe specification editor program corresponding to the current one of the plurality of intermediate arrangements of constituent pipes includes causing the determined application assistance interface to be displayed superimposed on a display of the pipe specification editor program.

21. The computer program product of claim 12, wherein:
the dynamically determined application assistance interface includes a plurality of suggested ones of the existing pipes to include as constituent pipes in a next intermediate arrangement of constituent pipes.

22. The computer program product of claim 12, further comprising:
receiving an indication from a user of interaction with the dynamically determined application assistance interface and, based thereon, determining a next intermediate arrangement of constituent pipes.

23. A computing system including one or more computing devices, configured to providing user assistance functionality associated with execution of a pipe specification editor application, wherein the pipe specification editor program includes functionality for a user to configure a pipe, for processing one or more syndication data feeds, via a pipe specification graphical user interface by sequentially defining a plurality of intermediate arrangements of constituent pipes, the computer system configured to:
dynamically determine an application assistance interface to be displayed based on a context of a current one of the plurality of intermediate arrangements of constituent pipes while a user is interacting with the pipe specification editor program; and
cause the dynamically determined application assistance interface to be displayed in conjunction with a display of the pipe specification editor program corresponding to the current one of the plurality of intermediate arrangements of constituent pipes.
